(19) United States
(12) Patent Application Publication
(10) Pub. No.: US 2011/0275529 A1
(43) Pub. Date: Nov. 10, 2011

(54) IDENTIFICATION AND CHARACTERISATION OF RECOMBINANT VIRAL GENE THERAPY VECTORS

(75) Inventor: Regine Heilbronn, Berlin (DE)

(73) Assignee: Charite Universitatsmedizin Berlin

(21) Appl. No.: 13/063,441

(22) PCT Filed: Sep. 21, 2009
(86) PCT No.: PCT/EP09/62196

§ 371 Date: Jul. 25, 2011

Related U.S. Application Data
(60) Provisional application No. 61/098,298, filed on Sep. 19, 2008.

(51) Int. Cl. C40B 30/04

(52) U.S. Cl. 506/9

(57) ABSTRACT

The present invention refers to a method for identifying or characterising a recombinant viral vector, particularly a recombinant adeno-associated virus (AAV) vector.

The present invention refers to a method for identifying or characterising a recombinant viral vector, particularly a recombinant adeno-associated virus (AAV) vector.

AAV-based gene therapy vectors have become increasingly important for clinical application, since long-term therapeutic successes have been reported in a variety of preclinical models and clinical phase 1 or 2 trials. Just recently three research groups reported encouraging from a handful of patients enrolled in phase 1 trials for Leber Congenital Amaurosis, a gene defect leading to early childhood blindness: An impressive enhancement of visual perception could be obtained in adolescents treated with AAV vector-mediated gene transfer of an intact gene copy into the retina of the already substantially blinded eye (Bainbridge et al., 2008 New Engl. J. Med., 358; Hauswirth et al. 2008 Hum. Gene Ther.; Maguire et al. 2008, New Engl. J. Med. 358). This success is in accordance with results of previous preclinical studies on dogs having the same genetic defect. In these dogs, the treated eye could be protected from blinding by preventive AAV vector application. The therapeutic effect has been found to be stable for nearly 10 years without side effects (Acland et al. 2001, Nature Genetics 28, 92).

A recombinant AAV-based gene therapy vector comprises a genome enclosed by a protein capsid which determines the serotype and mediates cellular targeting. For example, the most common AAV serotype 2 binds to a variety of cellular receptors present on various cell types. These include heparan sulfate proteoglycan (Summerford and Samulski 1998, J. Virol. 72, 1438), a predominant modification of many cell surface proteins. In addition, different co-receptors have been described: fibroblast growth factor receptor 1 (FGFR-1) (Qing 1999, Nature Medicine 5, 71), integrin αVβ5 (Summerford et al. 1999, Nature Medicine 5, 78), and hepatocyte growth factor receptor (c-met) (Kashiwakura et al. 2005, J. Virol. 79, 609) and possibly others. AAV serotype 4 binds to α2,3-O-linked sialic acid moieties and AAV serotype 5 binds to α2,3-N-linked sialic acid moieties (Walters et al. 2001, J. Biol. Chem. 276, 20610; Kaludov et al. 2001, J. Virol. 75, 6884). For AAV5, the platelet derived growth factor receptor (PDGFR) is described as co-receptor (Di Pasquale et al., 2003 Nature Medicine 9, 1306). AAV1 and AAV6 (a variant of AAV1 with six amino acid substitutions in the capsid protein) bind to α2,3-N- or α2,6-N-linked sialic acid moieties, which serve as modifications of various glycoproteins (Wu et al. 2006, J. Virol. 80, 9093). Meanwhile, further AAV serotypes have been isolated which are characterised by an altered cell tropism. The specific cellular receptors to which these new serotypes bind have not been characterized so far. Further, a variety of recombinant capsid variants comprising specific amino acid exchanges have been isolated for instance with the help of capsid display libraries. These variants allow an additional extension of the cellular targeting pattern.

Until now, AAV2 has been used for clinical studies in most cases. Increasingly, however, other serotypes are being employed due to their selectivity for specific cell types or organs. Thus, a differentiation of AAV vectors displaying variant capsids will play an increasing role.

Viral sub-types are usually identified by genetic analysis, such as PCR, cf. EP-A-1310571. AAV-based gene therapy vectors (or other viral gene therapy vectors) are mostly based on the AAV2 genome. The AAV capsid however may be derived of another AAV serotype, Therefore, AAV vectors are not distinguishable by genomic analysis. Whereas the wild-type viruses, e.g. the wild-type AAV carry the genes encoding their capsid proteins on their viral genomes and, thus, may be distinguished by PCR analysis, in AAV vectors the capsid protein coding genes are always deleted from the viral vector genome and replaced by a therapeutic transgene. For AAV vector production, AAV capsid genes are transiently expressed by helper plasmids, which are separately transfected into producer cells and cannot be encapsidated into AAV capsids.

Thus, since different capsid variants of AAV vectors (and other viral vectors) do not carry functional capsid genes and are not distinguishable by genomic analysis, a phenotypic differentiation of these capsid variants has to be carried out. For this purpose, serotype specific monoclonal antibodies can be used. It has been found, however, that a distinction of capsid variants with discrete single amino acid exchanges are difficult to distinguish. Further, the speed of selecting novel AAV variants makes it difficult to produce suitable antibodies within a reasonable time frame.

Alternatively, proteolytic methods optionally in combination with mass spectroscopy for the phenotypic identification of AAV capsid variants have been suggested (e.g. Van Vliet et al., in Methods in Molecular Biology, Vol. 437 (2008), pp. 51-91, Humana Press). It remains, however, open, if single amino acid substitutions may be reliably detected by these methods.

Thus, there is a need to provide methods for the phenotypic identification of virus gene therapy vectors to allow sensitive and specific distinction from other variants.

The present invention is based on the described binding properties of different serotypes of viral vectors, e.g. different AAV serotypes, to different glycan moieties, particularly glycan moieties present in side chains of glycoproteins. Surprisingly it was found that AAV serotypes may be easily distinguished by their glycan binding pattern. Thus, typical binding patterns for viral vector serotypes may be identified, e.g. by using glycan microarrays and the differential binding properties may be used for fine-mapping of different viral vector capsid variants.

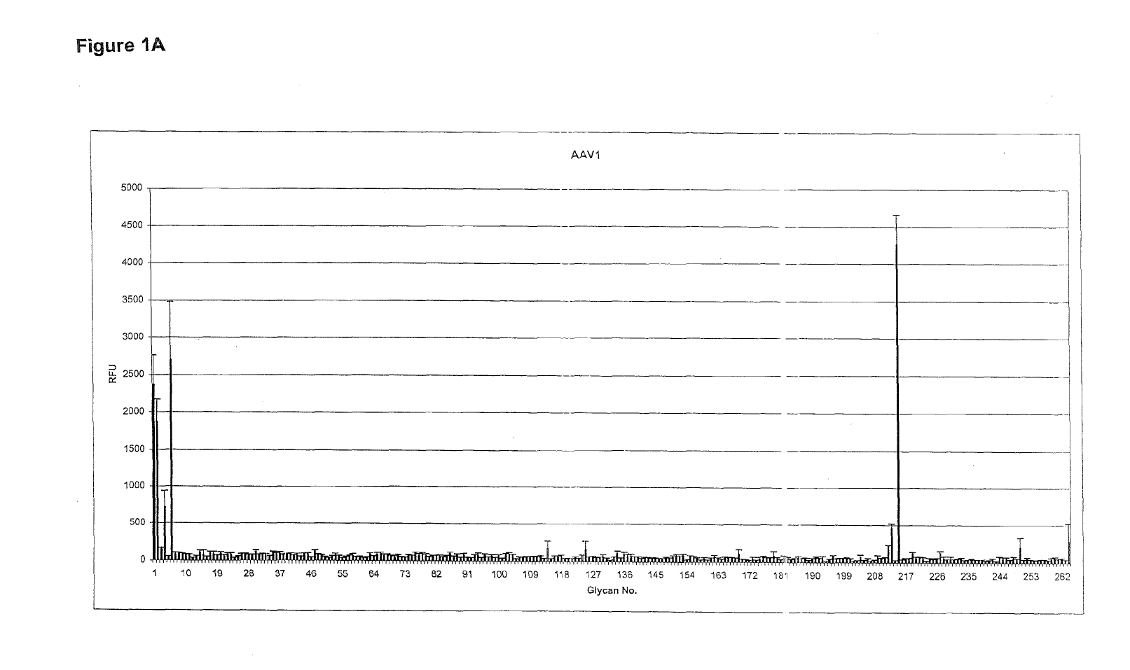

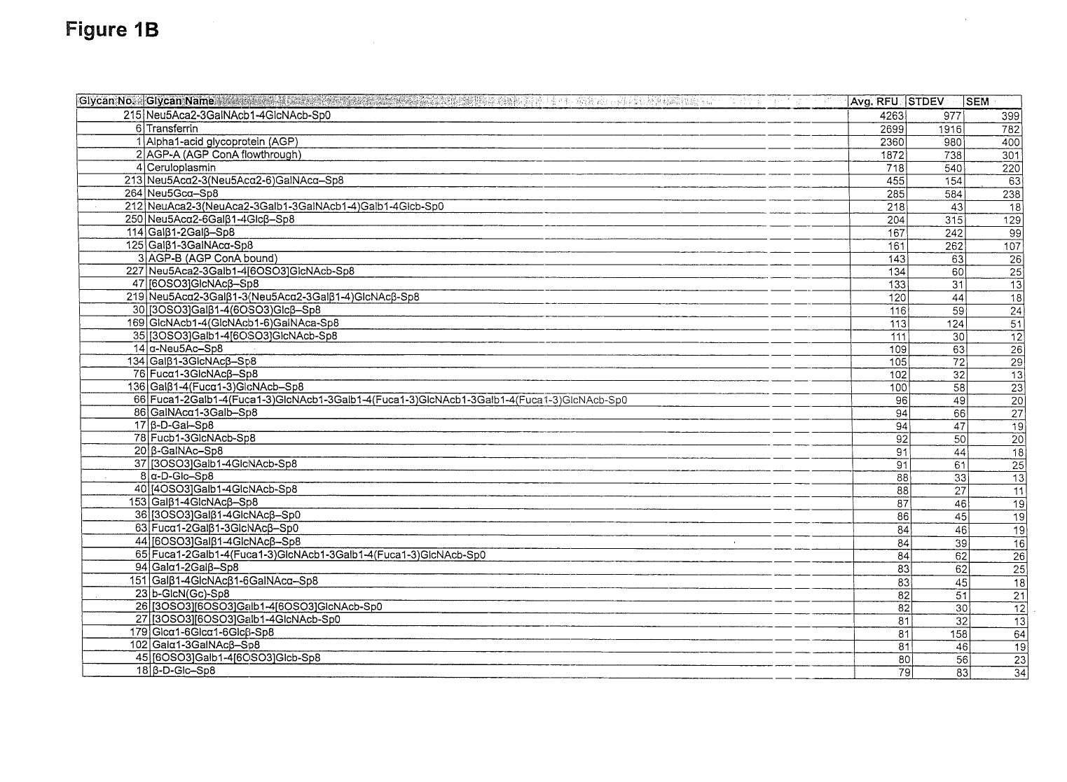

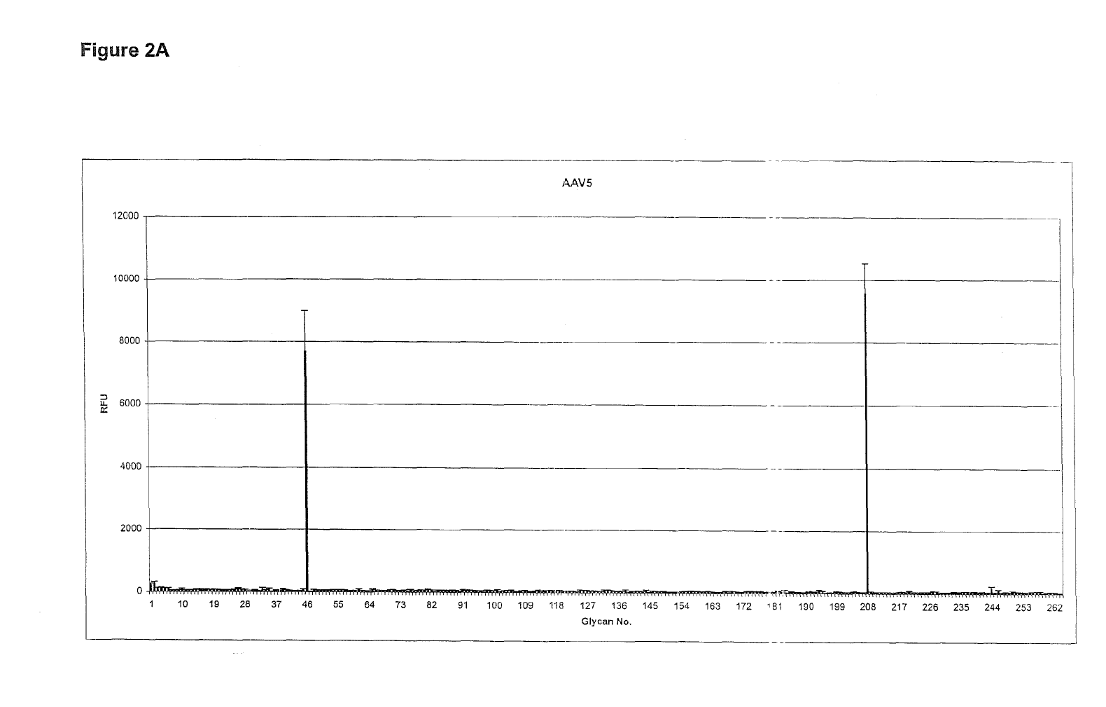

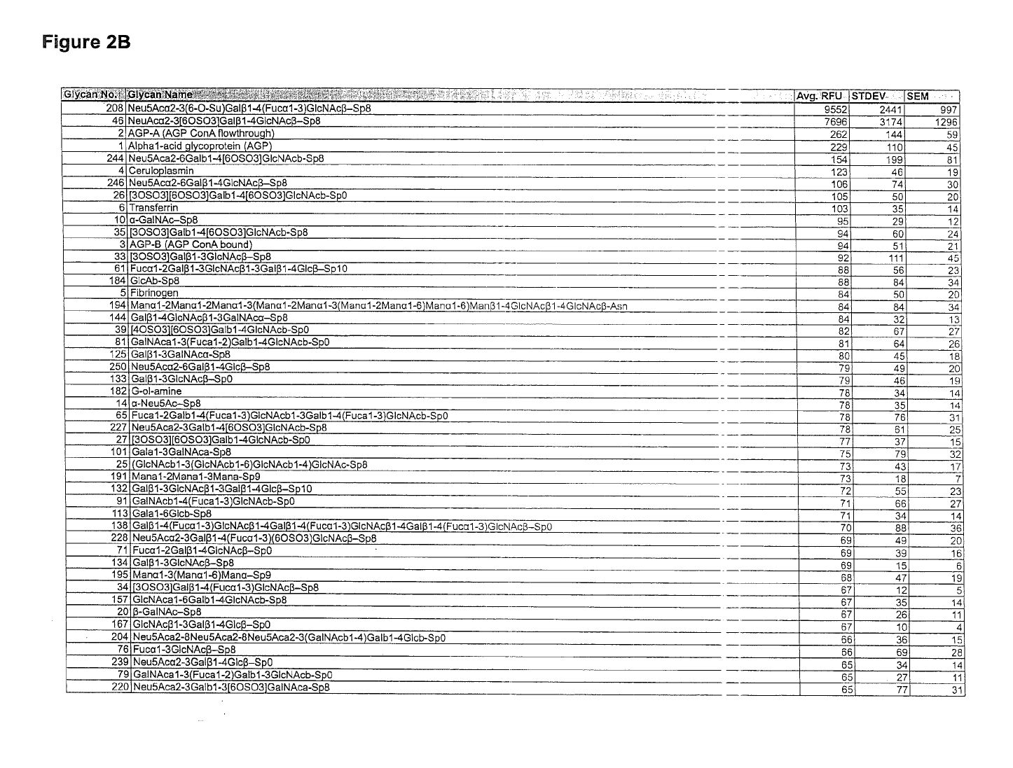

For the AAV serotypes 1 and 5 which bind biochemically similar cellular receptors, a different binding pattern was found on a glycan microarray with about 300 different glycan binding partners (FIG. 1 and FIG. 2). Further, it was found that each virus shows efficient binding only to a limited number, e.g. about 1, 2, 3, 4 or 5 of the tested 300 glycans, i.e. with an affinity which is about the factor 10-50 higher than the affinity towards other glycans. This shows that the glycan binding pattern of individual AAV serotypes is highly specific. The identification and characterisation of recombinant virus preparations based on their glycan binding pattern thus allows a simple and efficient detection and distinction of viral serotypes. Thus, the present invention is a diagnostic tool for the differentiation of viral gene therapy vectors, particularly AAV based viral gene therapy factors.

A subject-matter of the present invention is a method for identifying or characterising a recombinant viral vector comprising determining the binding of said recombinant viral vector to at least one glycan moiety, and optionally comparing the determined binding characteristics with a reference.

The term “recombinant viral vector” according to the present invention particularly refers to a viral vector used for gene therapy. The recombinant viral vector preferably comprises a nucleic acid genome and a capsid enclosing said genome, wherein the capsid is comprised of at least one viral capsid protein and wherein the genome does not comprise a functional gene encoding such at least one viral capsid protein.

More preferably, the genome of the viral vector comprises at least one transgene, e.g. a mammalian, e.g. human gene. Further, it is preferred that the genome is completely devoid of any nucleic acid sequence encoding a viral capsid protein or a fragment thereof having a length of at least 20, preferably at least 10, and more preferably at least 5 amino acids. The viral vector may comprise a single- or double-stranded DNA or RNA genome.

In a preferred embodiment of the present invention, the recombinant viral vector is an AAV-based vector, e.g. selected from vectors based on AAV serotypes 1-12 and variants thereof (Gao et al., J. Virol. 78 (2004), 6381-6388 and Mori et al., Virology 330 (2004), 375-383, the contents of which are herein incorporated by reference) including recombinant AAV vector variants. In other embodiments, the viral vector may be an adenovirus- or retrovirus-, e.g. lentivirus- or oncoretrovirus-based vector, or herpesvirus-, or poxvirus-based vector.

The method of the invention comprises contacting of the viral vector to be tested with at least one glycan moiety. The contacting step takes place under conditions at which the viral vector is capable of affinity binding to glycan moieties, e.g. room temperature or 37° C. and physiological salt and/or pH conditions. The term “glycan moiety” refers to a glycan, e.g. a mono-, oligosaccharide or polysaccharide group, wherein oligo- and polysaccharide groups may be linear or branched. The glycan moiety is optionally bound to a peptide or polypeptide chain. Preferably, the glycan moiety is immobilised on a solid phase, e.g. a particle, microtiter plate, chip etc. In order to determine binding of the viral vector to the glycan moiety, the viral vector and/or the glycan vector moiety may carry a detectable labelling group, e.g. a fluorescent labelling group. Preferably, the labelling group is coupled to the viral vector, e.g. by contacting an activated labelling group carrying a reactive group such as an active ester, e.g. an N-hydroxy succinimide group, or a maleimide group with a viral vector, wherein the reactive group provides covalent bonding to amino acid side chains, e.g. amino or thiol containing side chains of the viral vector capsid protein.

Preferably, the recombinant viral vector is contacted with a plurality of different glycan moieties in order to determine a glycan binding pattern. For example, the viral vector may be contacted with at least 2, at least 5, at least 10 or even more glycan moieties.

In an especially preferred embodiment of the invention, a plurality of glycan moieties is immobilised on a solid surface, e.g. a chip surface. Especially preferred is the use of a glycan array as described by Blixt et al. (Proc. Natl. Acad. Sci. USA 101 (2004), 17033-17038, the content of which is herein incorporated by reference). The array may be produced by coupling of amine-functionalised glycans or glycan conjugates, e.g. glycan peptide or polypeptide conjugates, to amine-reactive, e.g. N-hydroxysuccinimide-activated glass slides, e.g. a glass surface. Suitable glycan arrays are e.g. available from the Consortium for Functional Glycomics (CFG).

A preferred glycan chip comprises glycan moieties suitable for distinction between different AAV serotypes, e.g. between serotypes AAV-1 and AAV-5.

The invention may further comprise as an optional step a comparison of the determined binding characteristics with a reference, e.g. one or several viral vectors for which the binding characteristics are already known.

A further subject-matter of the present invention is a kit comprising a glycan binding array, i.e. a solid phase, e.g. a chip having immobilised thereto a plurality of different glycan moieties, for the identification and/or characterisation of viral vectors, particularly for the identification of AAV-based vectors. Further, the kit may comprise labelling reagents for coupling detectable labelling groups to viral vector capsids and/or one or several reference viral vectors. The kit may be used for determining the identity and/or purity of vectors during or after preparation, i.e. as a quality control agent, particularly for determining the purity of therapeutic viral vector preparations.

The present invention is further illustrated by the following example:

### EXAMPLE

### Determining Binding Characteristics of AAV Serotype 1 and AAV Serotype 5 to a Glycan Array

The binding of AAV serotype 1 and AAV-serotype 5 towards a printed glycan array from CFG containing 264 different natural and synthetic glycans (including sialylated sugars with different linkages and modifications, for example, sulfatation) was tested.

The binding characteristics of AAV serotype 1 are shown in FIGS. 1A and B. Preferred binding of AAV1 was found to glycans 215 (Neu5Acα2-3GalNAcβ1-4GlcNAcβ-Sp0), 6 (transferrin), 1(α1-acid glycoprotein) and 2 (AGP-A concanavalin A flowthrough).

The binding characteristics of AAV serotype 5 are shown in FIGS. 2A and 2B. AAV5 shows intense binding to glycans 208 (Neu5Acα2-3(6-O-Su)Galβ1-4(Fucα1-3)GlcNAcβ-Sp8 and 46 (NeuAcα2-3(6OSO3)Galβ1-4GlcNAcβ-Sp8).

A comparison of FIGS. 1 and 2 shows that AAV1 and AAV5 have completely different binding patterns on the glycan array. Thus, on the basis of this glycan binding pattern, a simple and clear differentiation between AAV1- and AAV5-based recombinant viral vector preparations is possible.

It is assumed that other AAV-based viral vector preparations show a distinctive glycan array binding pattern and, thus, may be distinguished from variant serotypes.

1. A method for identifying or characterising a recombinant viral vector comprising the binding of said recombinant viral vector to at least one glycan moiety, and optionally comparing the determined binding characteristics with a reference.

2. The method of claim 1, wherein the recombinant viral vector comprises a nucleic acid genome and a capsid enclosing said genome, wherein the capsid is comprised of at least one viral capsid protein, and wherein the genome does not comprise a functional gene encoding said at least one viral capsid protein.

3. The method of claim 1 or 2, wherein the recombinant viral vector is selected from the group consisting of adeno-associated virus (AAV)-, adenovirus-, or retrovirus-, or herpesvirus-, or poxvirus-based vectors.

4. The method of claim 3, wherein the viral vector is an AAV-based vector.

5. The method of claim 4, wherein the AAV-based vector is selected from AAV serotypes 1-12 and variants thereof.

6. The method of any one of claims 1 to 5, wherein the glycan moiety is selected from mono-, oligo- and polysaccharide groups optionally bound to a peptide or polypeptide chain.

7. The method of any one of claims 1 to 6, wherein the glycan moiety is immobilised on a solid phase.

8. The method of any one of claims 1 to 7, wherein the viral vector and/or the glycan moiety carries a detectable labelling group.

9. The method of any one of claims 1 to 8, wherein the viral vector is contacted with a plurality of different glycan moieties.

10. A kit comprising a glycan binding array for use in the identification and/or characterisation of viral vectors.

11. The kit of claim 10 for use as a quality control agent, particularly for determining the purity of therapeutic viral vector preparations.
